(19) United States
(12) Patent Application Publication
(10) Pub. No.: US 2026/0342019 A1
(43) Pub. Date: Oct. 29, 2026

(54) ELECTRICAL CONNECTOR AND TERMINAL MODULE FOR THE ELECTRICAL CONNECTOR

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventor: MING-CHING CHEN, New Taipei (TW)

(21) Appl. No.: 19/656,296

(22) Filed: Apr. 23, 2026

(30) Foreign Application Priority Data
Apr. 29, 2025 (CN) 202510559479.0

(51) Int. Cl. H01R 13/6585

(52) U.S. Cl. CPC H01R 13/6585

(57) ABSTRACT

An electrical connector includes an insulative housing and a terminal module housed in the insulative housing. The terminal module includes a first terminal module and a second terminal module disposed below the first terminal module. The first terminal module includes: a row of terminals arranged in a transverse direction and including plural pairs of signal terminals capable of transmitting differential signals; an insulator holding the row of terminals; an upper shielding plate disposed above the row of terminals; a lower shielding plate disposed below the row of terminals; and an isolating member. The isolating member includes a first portion and a plurality of second portions extending from the first portion and each second portion is disposed between two adjacent pairs of signal terminals.

### BACKGROUND OF THE INVENTION

### Field of the Invention

The present invention relates generally to an electrical connector and terminal module for the electrical connector, and particularly to an electrical connector and terminal module for the electrical connector for transmitting high-frequency.

### Description of Related Arts

With the development of networks and big data, the requirements for the speed of signal transmission in connectors are becoming increasingly higher. In order to meet the demands for higher signal transmission, the frequency of signal transmission is also gradually increasing. However, this faces the problem that high-frequency signal interference makes it difficult to improve signal transmission.

U.S. Pat. No. 11,322,869 discloses an electrical connector comprising a row of terminals arranged in the transverse direction and a shielding plate disposed on one side of the row of terminals. The signal terminals include a plurality of pairs of signal terminals for transmitting signals. The shielding plate only shields the row of terminals on one side in the vertical direction, so there is signal interference between each pair of signal terminals in the transverse direction.

Improved electrical connector and terminal module for the electrical connector are desired.

### SUMMARY OF THE INVENTION

The objective of the present invention is to provide an electrical connector for transmitting high-frequency.

To achieve the above object, an electrical connector comprises: an insulative housing; and a terminal module housed in the insulative housing, the terminal module comprising: a first terminal module comprising: a row of terminals arranged in transverse direction, the row of terminals includes a plurality of pairs of signal terminals capable of transmitting differential signals; an insulator holding the row of terminals; an upper shielding plate disposed above the row of terminals; a lower shielding plate disposed below the row of terminals; and an isolating member; and a second terminal module disposed below the first terminal module; wherein the isolating member includes a first portion and a plurality of second portions extending from the first portion, each second portion being disposed between two adjacent pairs of signal terminals.

The objective of the present invention is to provide a terminal module for transmitting high-frequency.

To achieve the above object, a terminal module for an electrical connector comprises: a row of terminals arranged in a transverse direction, each terminal comprising: a contact portion, a mounting portion disposed opposite to the contact portion, and a connecting portion located between the contact portion and the mounting portion, the row of terminals including a plurality of pairs of signal terminals capable of transmitting differential signals; an insulator holding the row of terminals; an upper shielding plate disposed above the row of terminals; a lower shielding plate disposed below the row of terminals; and an isolating member; wherein the isolating member includes a first portion and a plurality of second portions extending from the first portion, each second portion being disposed between two adjacent pairs of signal terminals.

Compared to prior art, the terminal module of the electrical connector in the present invention combines an upper shielding plate, a lower shielding plate, and an isolating member to shield a pair of signal terminals from four directions, providing excellent shielding performance and better high-frequency characteristics.

### BRIEF DESCRIPTION OF THE DRAWING

FIG. 1 is a perspective view of an electrical connector according to the present invention;

FIG. 2 is another perspective view of the electrical connector of FIG. 1;

FIG. 3 is an exploded view of the electrical connector of FIG. 1;

FIG. 4 is a further exploded of the electrical connector of FIG. 3;

FIG. 5 is another exploded view of the electrical connector of FIG. 3;

FIG. 6 is a perspective view of the first terminal module of the electrical connector of FIG. 4;

FIG. 7 is another perspective view of the metal cage of FIG. 6;

FIG. 8 is a side view of the first terminal module of FIG. 6;

FIG. 9 is a cross-sectional view of the first terminal module of FIG. 6;

FIG. 10 is a perspective view of the first terminal module FIG. 6, without conductive member;

FIG. 11 is an exploded view of the first terminal module of FIG. 6;

FIG. 12 is another exploded view of the first terminal module of FIG. 11;

FIG. 13 is a perspective view of the first terminal module FIG. 6, without the upper shielding plate;

FIG. 14 is an exploded view of the first terminal module of FIG. 13.

FIG. 15 is a perspective view of the upper shielding plate and isolating member of the first module of FIG. 14, after they are assembled;

FIG. 16 is a perspective view of the upper shielding plate of FIG. 14; and

FIG. 17 is another perspective view of the upper shielding plate of FIG. 16.

### DETAILED DESCRIPTION OF THE PREFERRED EMBODIMENT

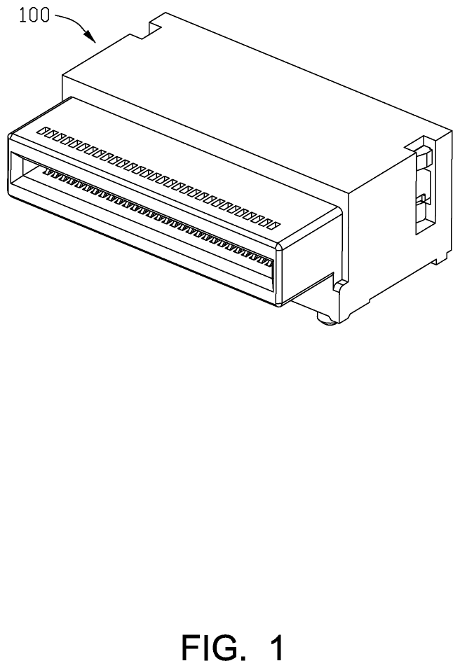

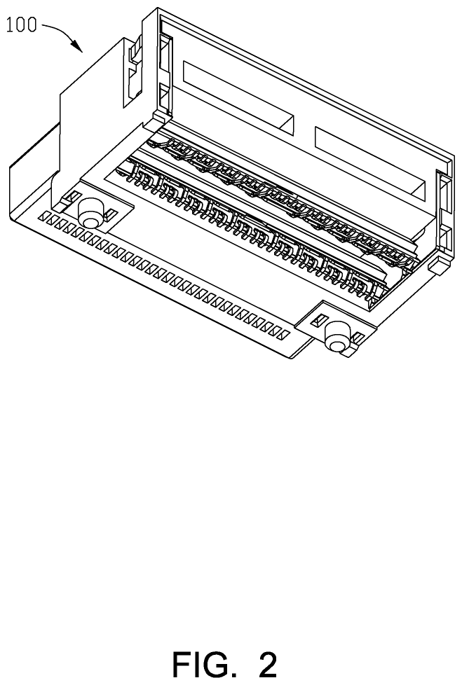

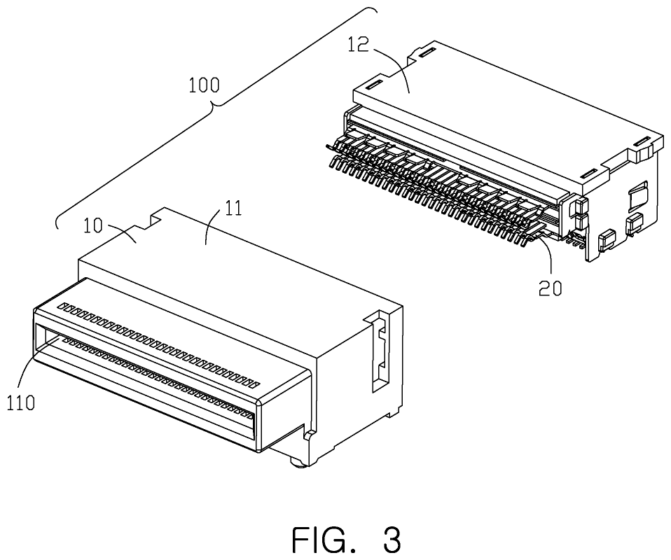

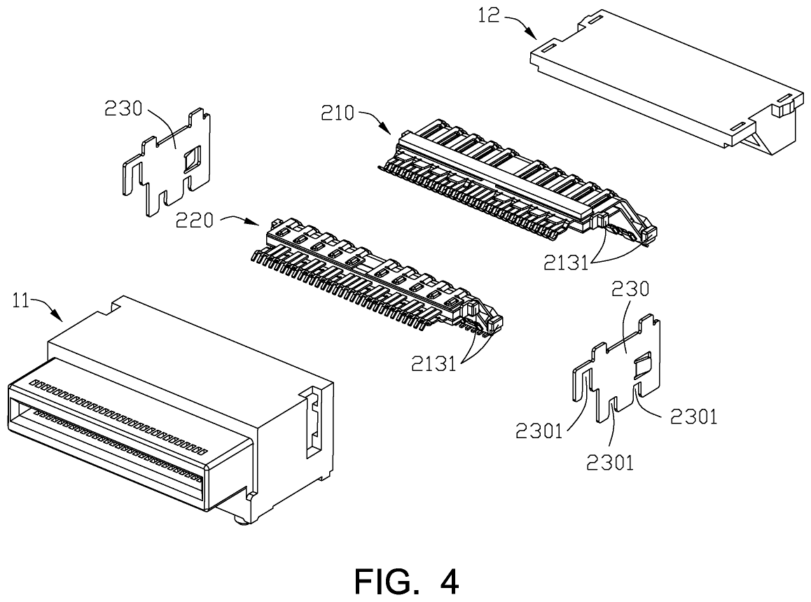

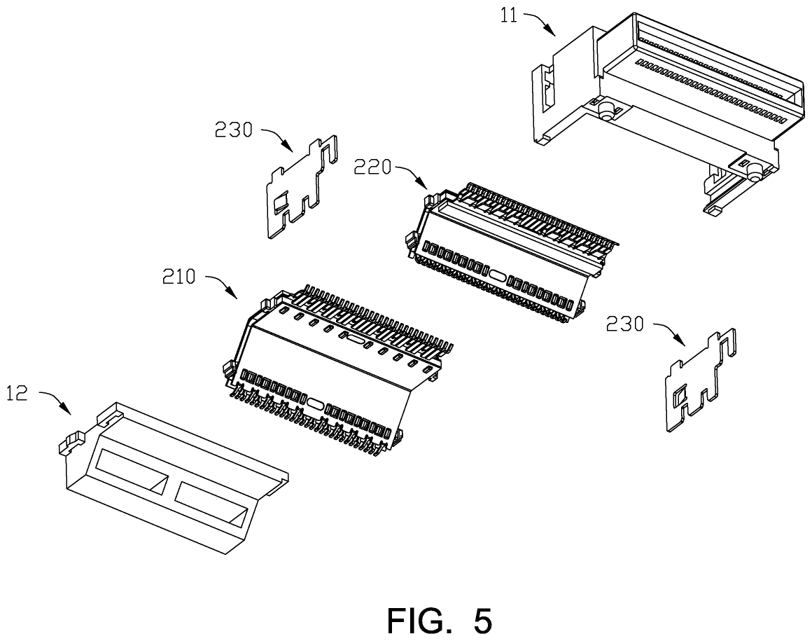

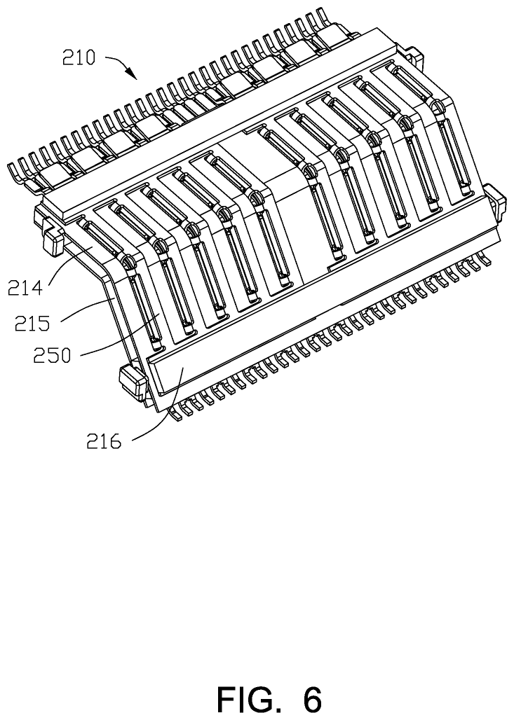

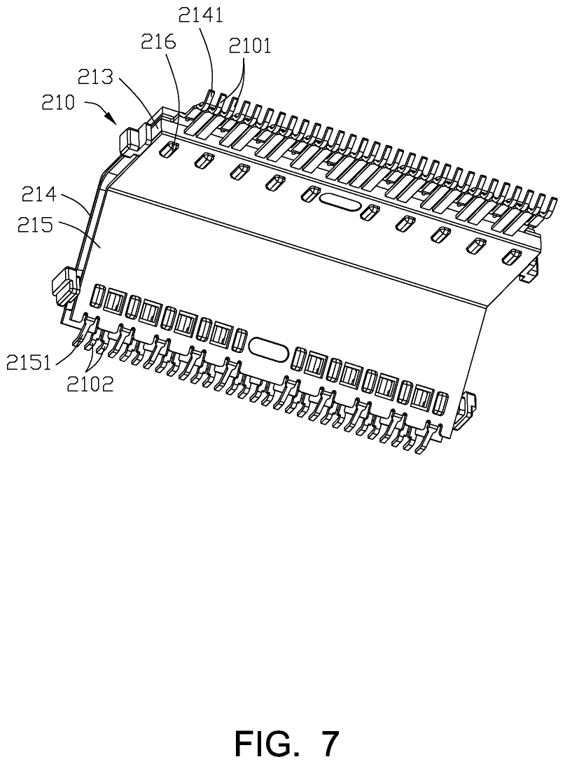

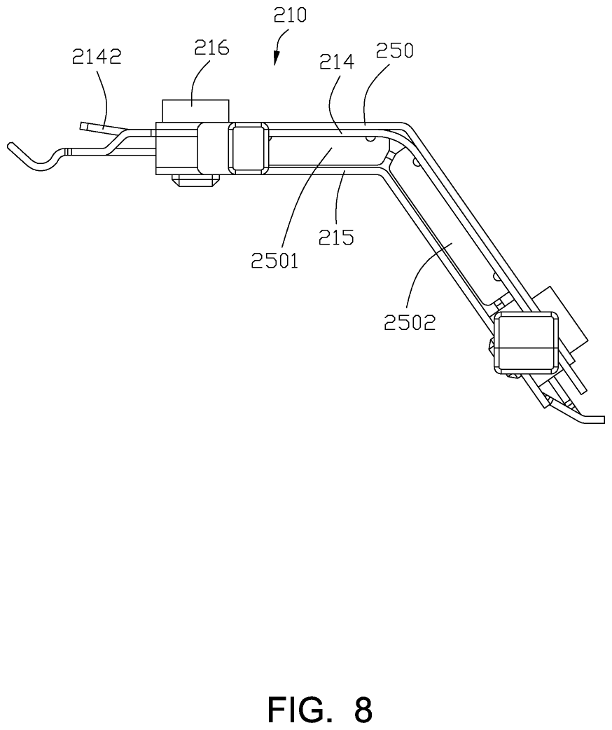

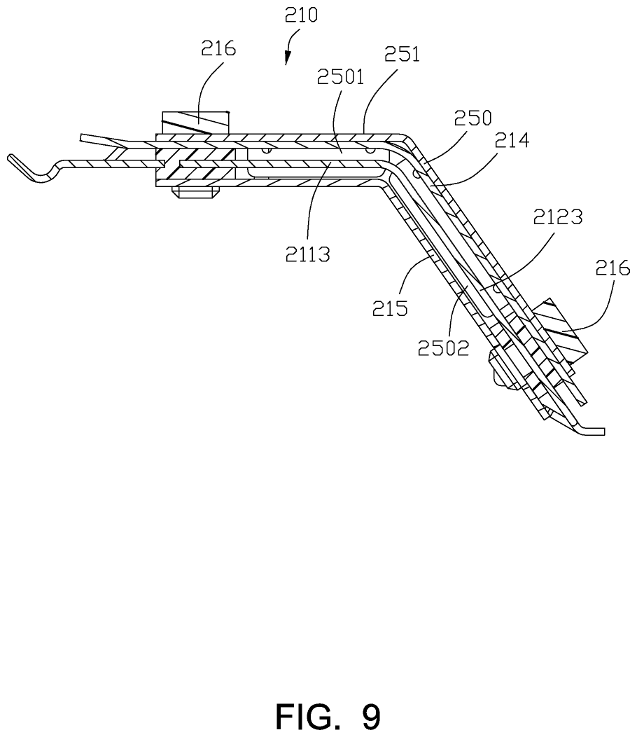

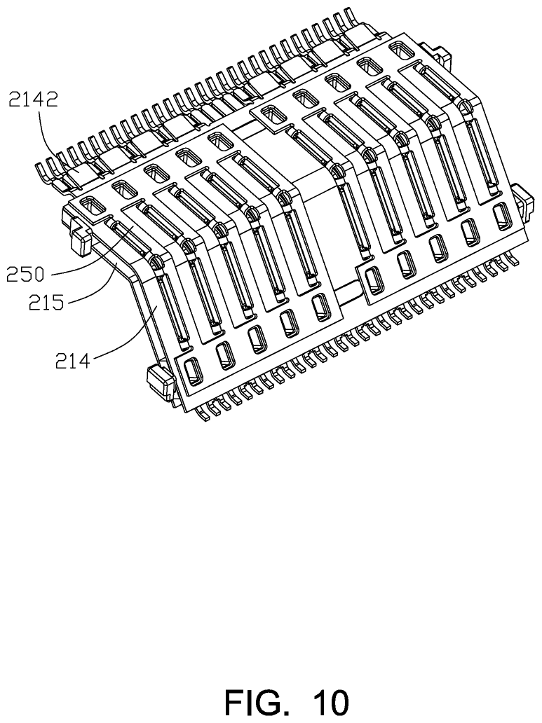

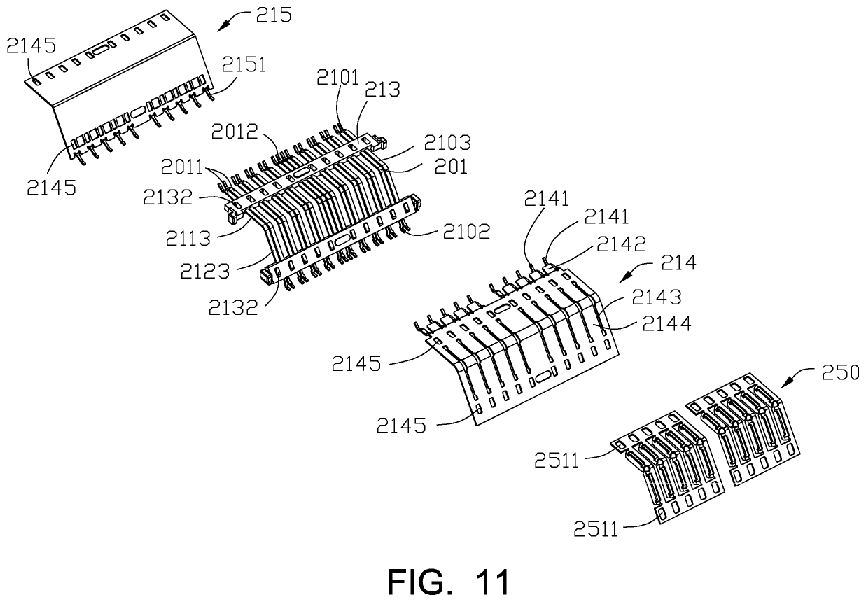

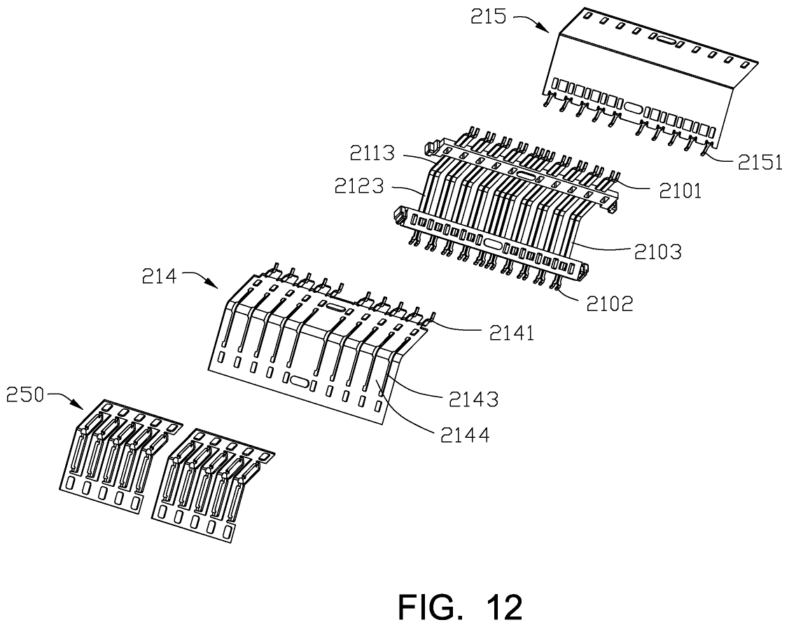

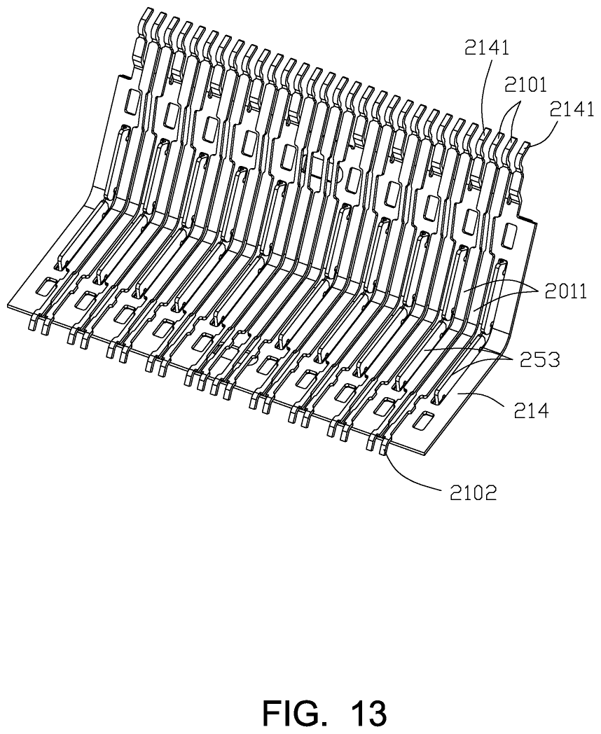

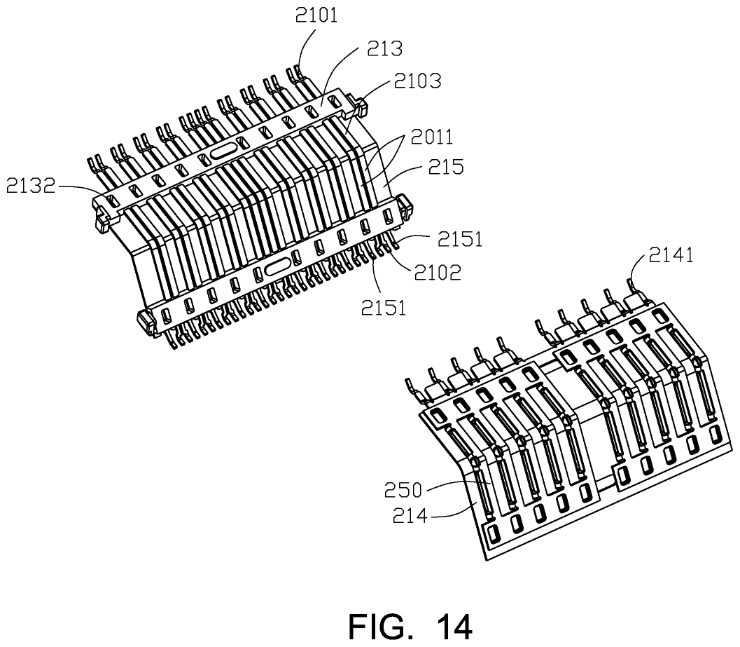

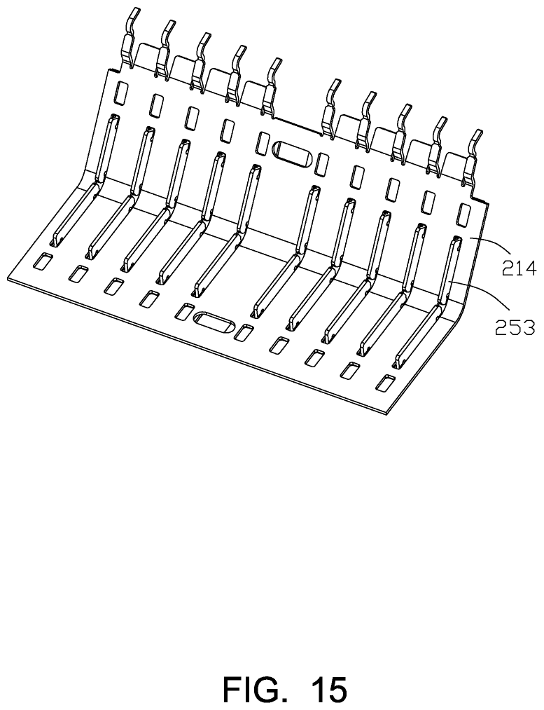

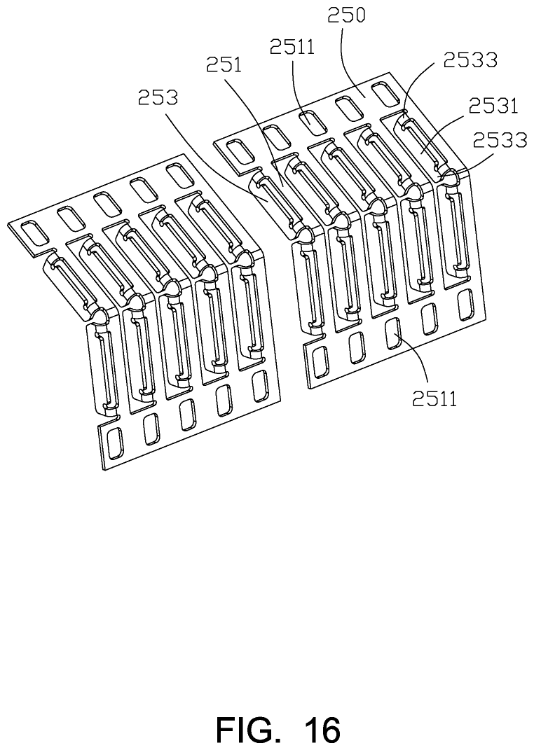

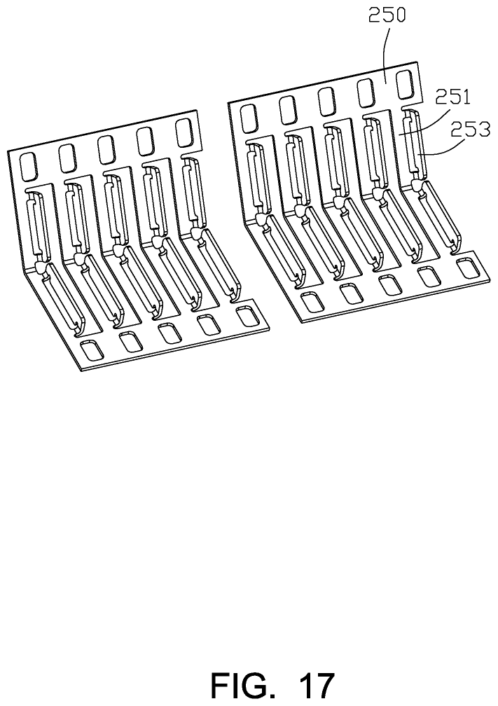

Referring to FIGS. 1-17, an electrical connector 100 in accordance with the present invention is shown. The electrical connector 100 can be mounted onto an external circuit board (not shown) and can mate with a mating connector (not shown). The electrical connector 100 includes an insulative housing 10 and a terminal module 20 housed within the insulative housing 10.

The insulative housing 10 includes a main body portion 11 and a cover portion 12 that can mate with the main body portion 11. The main body portion 11 has a mating port 110 that can mate with the mating connector.

The terminal module 20 includes a first terminal module 210, a second terminal module 220 disposed below the first terminal module 210, and a pair of fixing tabs 230 that secure the first terminal module 210 and the second terminal module 220. The front regions of the first terminal module 210 and the second terminal module 220 together form a mating area for electrical connection with the two opposite surfaces of the tongue of the mating connector. The fixing tabs 230 secures the first terminal module 210, the second terminal module 220, and the cover portion 12 together, and then assembles them into the main body portion 11.

The first terminal module 210 includes a row of terminals 201 arranged at intervals in a transverse direction, an insulator 213 holding the row of terminals 201, an upper shielding plate 214 disposed above the row of terminals 201, a lower shielding plate 215 disposed below the row of terminals 201, an isolating member 250, and a conductive member 216. The conductive member 216 is mechanically and electrically connected to the upper shielding plate 214, the lower shielding plate 215, and the isolating member 250.

The row of terminals 201 includes a plurality of pairs of signal terminals 2011 for transmitting differential signals and sideband terminals 2012 for transmitting other signals such as low-speed, power, and control signals. Specifically, in the invention, the first row of terminals 201 includes four sideband terminals 2012 and eight pairs of signal terminals 2011. The eight pairs of signal terminals 2011 are evenly divided into two groups, which are respectively arranged on two sides of the sideband terminals 2012. In other embodiments, only signal terminals 2011 may be provided. Each terminal in the row of terminals 201 includes a contact portion 2101 for mating with the mating connector, a mounting portion 2102 disposed opposite the contact portion 2101 for mating with the circuit board, and a connecting portion 2103 located between the contact portion 2101 and the mounting portion 2102. The connecting portion 2103 includes a horizontal portion 2113 connected to the rear part of the contact portion 2101, and an inclined portion 2123 connecting the horizontal portion 2113 and the mounting portion 2102.

The upper shielding plate 214 is disposed on one side of the row of terminals 201 and is spaced from the row of terminals 201 by a first distance, while the lower shielding plate 215 is positioned on the other side of the row of terminals 201 and is spaced from the row of terminals 201 by a second distance. The first distance is equal to the second distance. The upper shielding plate 214 and the lower shielding plate 215 surround the signal terminals 2011 of the row of terminals 201, forming a strip-line structure similar to that of a PCB design, in order to achieve better high-speed transmission performance. For ease of understanding, the distance referred to here means the perpendicular distance at corresponding positions.

Each of the upper shielding plate 214 and the lower shielding plate 215 is metal plates, and are bent to conform to the overall extending shape of the first terminal module 210. The upper shielding plate 214 and the lower shielding plate 215 are spaced from the row of terminals 201 by the insulator 213. The upper shielding plate 214 has a plurality of through holes 2143 and covering portions 2144 located between adjacent through holes 2143. Each covering portion 2144 is aligned with a corresponding pair of signal terminals 2011, and the width of the covering portion 2144 in the transverse direction is greater than the width of the corresponding pair of signal terminals 2011. Specifically, the through holes 2143 are elongated in shape.

The upper shielding plate 214 has a plurality of grounding contact portions 2141, and the lower shielding plate 215 has a plurality of grounding mounting portions 2151. The plurality of grounding contact portions 2141 and the plurality of grounding mounting portions 2151 are integrally stamped from the corresponding shielding plates. The grounding contact portions 2141 are aligned with the contact portions 2101 of the first row of terminals 201 in the transverse direction, and the contact portions 2101 of each pair of signal terminals 2011 are located between an adjacent pair of grounding contact portions 2141. Similarly, the plurality of grounding mounting portions 2151 are aligned with the mounting portions 2102 of the first row of terminals 201 in the transverse direction, and the mounting portions 2102 of each pair of signal terminals 2011 are located between an adjacent pair of grounding mounting portions 2151. The upper shielding plate 214 also includes overhanging features for impedance control, such as front extension portions 2142 located between two adjacent grounding contact portions 2141.

The isolating member 250 is formed by stamping and bending a metal sheet. The isolating member 250 is disposed separately from both the upper shielding plate 214 and the lower shielding plate 215 of the first terminal module 210. The isolating member 250 includes a first portion 251 and a plurality of second portions 253 extending from the first portion 251. In this invention, two isolating members 250 are included, with one isolating member 250 disposed on each area where signal terminals 2011 are located. In other embodiments, only one isolating member 250 may be provided. The first portion 251 is located within the plane of the metal sheet, while the second portions 253 are bent from the first portion 251. The first portion 251 is positioned on the outer side of the upper shielding plate 214 and is in contact with the outer surface of the upper shielding plate 214. The plurality of second portions 253 are arranged perpendicular to the first portion 251. Each second portion 253 is positioned between two adjacent pairs of signal terminals 2011 to reduce signal crosstalk between the two adjacent pairs of signal terminals 2011. Specifically, the plurality of second portions 253 are inserted between different pairs of signal terminals 2011 through the through holes 2143 of the upper shielding plate 214. The thickness of each second portion 253 is equal to the width of the through hole 2143 in the transverse direction. Due to manufacturing and assembly tolerances, the width of the through hole 2143 in the transverse direction is no greater than 0.05 mm compared to the thickness of the second portion 253.

The second portion 253 includes a disconnected section 2531 that is separated from the first portion 251, and connecting sections 2533 on both sides of the disconnected section 2531 that are joined to the metal plate. The disconnected section 2531 of the second portion 253 extends toward the upper shielding plate 214 beyond the outer surface of the upper shielding plate 214, while the second portion 253 extends toward the lower shielding plate 215 to the upper surface of the lower shielding plate 215. The lower shielding plate 215 is intact at the position corresponding to the second portion 253. Due to assembly tolerances, the distance between the second portion 253 and the lower shielding plate 215 is no greater than 0.05 mm. The second portion 253 includes a vertical second portion 2501 that separates the horizontal portions 2113 of two adjacent pairs of signal terminals 2011, and an inclined second portion 2502 that separates the inclined portions 2123 of the two pairs of signal terminals 2011. The first portion 251 has fixing holes 2511 on both sides in the direction of terminal extension. The upper shielding plate 214 and the lower shielding plate 215 cover the signal terminals 2011 in the vertical direction, and the isolating member 250 separates pairs of signal terminals 2011 in the transverse direction.

There are two insulators 213, the two insulators 213 are positioned near the contact portion 2101 and near the mounting portion 2102 of the connecting portion 2103. Each insulator 213 is elongated and extends in the transverse direction. At both ends in the transverse direction, each insulator 213 extends beyond the upper shielding plate 214 and the lower shielding plate 215, and a protrusion 2131 is formed at the extended part. The pair of fixing tabs 230 is provided with mounting openings 2301 corresponding to the protrusions 2131. Each insulator 213 has a plurality of openings 2132. Both the upper shielding plate 214 and the lower shielding plate 215 have a plurality of through holes 2145. The through holes 2145 of the upper shielding plate 214 and the lower shielding plate 215 are aligned with the corresponding openings 2132. Each insulator 213 has an opening 2132 between two pair of adjacent signal terminals 2011. The conductive member 216 passes through the fixing hole 2511 of the corresponding isolating member 250, the through holes 2145 of the upper shielding plate 214 and the lower shielding plate 215, and the openings 2132 of the insulator 213. The conductive member 216 is formed by injection molding, electrically connecting the isolating member 250, the upper shielding plate 214, and the lower shielding plate 215 together to achieve better signal integrity (SI) performance.

The structure of the second terminal module 220 is similar to that of the first terminal module 210, with the main difference being that it is relatively shorter.

In the electrical connector 100 of the present invention, the upper shielding plate 214, the lower shielding plate 215, and the isolating member 250 together shield a pair of signal terminals 2011 from four directions along the terminal path, providing good shielding. Furthermore, the isolating member 250 is designed as a one-piece, which can be installed on the first terminal module 210 at once, making installation convenient and saving time, making installation convenient and saving labor time.

1. An electrical connector comprising:
an insulative housing; and
a terminal module housed in the insulative housing, the terminal module comprising:
a first terminal module comprising:
a row of terminals arranged in a transverse direction, the row of terminals including a plurality of pairs of signal terminals capable of transmitting differential signals;
an insulator holding the row of terminals;
an upper shielding plate disposed above the row of terminals;
a lower shielding plate disposed below the row of terminals; and
an isolating member; and
a second terminal module disposed below the first terminal module; wherein
the isolating member includes a first portion and a plurality of second portions extending from the first portion, each second portion being disposed between two adjacent pairs of signal terminals.

2. The electrical connector as claimed in claim 1, wherein the isolating member is formed by stamping and bending a metal sheet, the first portion is located in the plane of the metal sheet and the second portion is bent from the first portion.

3. The electrical connector as claimed in claim 2, wherein the upper shielding plate has a plurality of through holes, each of which is located between two adjacent pairs of signal terminals in the transverse direction, the first portion is located on the outer side of the upper shielding plate and is attached to the outer surface of the upper shielding plate, and the plurality of second portions are inserted between different pairs of signal terminals through the through holes.

4. The electrical connector as claimed in claim 3, wherein the width of the through hole in the transverse direction is equal to the thickness of the second portion.

5. The electrical connector as claimed in claim 4, wherein the second portion includes a disconnected section separated from the first portion, and connected sections on two sides of the disconnected section that are joined to the first portion.

6. The electrical connector as claimed in claim 5, wherein the disconnected section extends toward the upper shielding plate beyond the outer surface of the upper shielding plate, and the second portion extends toward the upper surface of the lower shielding plate.

7. The electrical connector as claimed in claim 6, wherein the lower shielding plate is intact at the position corresponding to the second portion and contact the second portion.

8. The electrical connector as claimed in claim 3, wherein each signal terminal includes a contact portion, a mounting portion disposed opposite the contact portion, and a connecting portion located between the contact portion and the mounting portion, the connecting portion includes a horizontal portion located behind the contact portion and an inclined portion connecting the horizontal section and the mounting portion, the second portion includes a vertical second section that separates the horizontal sections of two adjacent pairs of signal terminals, and an inclined second section that separates the inclined sections of the two pairs of signal terminals.

9. The electrical connector as claimed in claim 3, further comprising a conductive member, the conductive member electrically connects the upper shielding plate, the lower shielding plate, and the isolating member.

10. The electrical connector as claimed in claim 1, wherein the insulator has a plurality of openings, and the upper shielding plate and lower shielding plate has a plurality of through holes aligned with the openings, the isolating member has a plurality of fixing holes aligned with the openings and the through holes, the conductive members is integrally formed and passes through the corresponding fixing holes, the through holes, and the openings.

11. The electrical connector as claimed in claim 10, wherein at least one of the upper shielding plate and the lower shielding plate is integrally formed with a plurality of grounding contact portions, which are aligned in the transverse direction with the contact portions of the plurality of signal terminals in the row of terminals.

12. The electrical connector as claimed in claim 11, wherein at least one of the upper shielding plate and the lower shielding plate is integrally formed with a plurality of grounding mounting portions, which are aligned in the transverse direction with the mounting portions of the plurality of signal terminals in the row of terminals.

13. A terminal module for an electrical connector, comprising:
a row of terminals arranged in a transverse direction, each terminal comprising a contact portion, a mounting portion disposed opposite to the contact portion, and a connecting portion located between the contact portion and the mounting portion, the row of terminals including a plurality of pairs of signal terminals capable of transmitting differential signals;
an insulator secured to the row of terminals;
an upper shielding plate disposed above the row of terminals;
a lower shielding plate disposed below the row of terminals; and
an isolating member; wherein
the isolating member includes a first portion and a plurality of second portions extending from the first portion, and each second portion being disposed between two adjacent pairs of signal terminals.

14. The terminal module as claimed in claim 13, wherein the isolating member is formed by stamping and bending a metal sheet, and the second portions are formed by bending from the plane of the metal sheet.

15. The terminal module as claimed in claim 13, wherein the upper shielding plate has a plurality of through holes, each through hole is located between two adjacent pairs of signal terminals, the first portion of the isolating member is in contact with the outer surface of the upper shielding plate, and each second portion is inserted between two adjacent pairs of signal terminals through the through holes.

16. The terminal module as claimed in claim 15, wherein the second portions are perpendicular to the upper shielding plate and the lower shielding plate.

17. The terminal module as claimed in claim 13, wherein the upper shielding plate is spaced from the row of terminals by a first distance, the lower shielding plate is spaced from the row of terminals by a second distance, and the first distance is equal to the second distance.

18. The terminal module as claimed in claim 13, wherein the upper shielding plate has a plurality of grounding contact portions, and the lower shielding plate has a plurality of grounding mounting portions.

19. The terminal module as claimed in claim 18, wherein the grounding contact portions are aligned with the contact portions of the first row of terminals in the transverse direction, and the plurality of grounding mounting portions are aligned with the mounting portions of the first row of terminals in the transverse direction.

20. The terminal module as claimed in claim 13, wherein the upper shielding plate includes extension portions located between two adjacent grounding contact portions.
